(19) United States
(12) Patent Application Publication
(10) Pub. No.: US 2023/0037890 A1
(43) Pub. Date: Feb. 9, 2023

(54) METHOD FOR PRODUCING A MARKED POLYMER, MARKER, USE OF THE MARKER, AND MARKED POLYMER

(71) Applicant: FRAUNHOFER-GESELLSCHAFT ZUR FÖRDERUNG DER ANGEWANDTEN FORSCHUNG E.V., München (DE)

(72) Inventors: Ralf SCHLEGEL, Halle (Saale) (DE); Mario BEINER, Halle (Saale) (DE)

(73) Assignee: FRAUNHOFER-GESELLSCHAFT ZUR FÖRDERUNG DER ANGEWANDTEN FORSCHUNG E.V., München (DE)

(21) Appl. No.: 17/784,229

(22) PCT Filed: Nov. 19, 2020
(86) PCT No.: PCT/EP2020/082638

§ 371 Date: Jun. 10, 2022

(30) Foreign Application Priority Data
Dec. 12, 2019 (DE) 10 2019 219 469.9

(51) Int. Cl. C08K 3/10

(52) U.S. Cl. CPC C08K 3/10; C08K 2201/005

(57) ABSTRACT

A method for the preparation of a labelled polymer is presented. The method comprises mixing polymer precursors with a marker and polymerizing the polymer precursors to form a labelled polymer or, alternatively, mixing a polymer with a marker to form a labelled polymer. The method is characterized in that the marker comprises or consists of particles, which comprise or consist of a metal and/or a semimetal, the marker having at least three atomic species having a different atomic number. A marker and a labelled polymer are also provided. In addition, uses of the marker according to the invention are proposed. The marker according to the invention does not significantly affect the properties of the polymer and allows coded information in a wide variety of polymers to be read out in a simple and rapid manner and over long polymer lifetimes.

A method for the preparation of a labelled polymer is presented. The method comprises mixing polymer precursors with a marker and polymerizing the polymer precursors to form a labelled polymer or, alternatively, mixing a polymer with a marker to form a labelled polymer. The method is characterized in that the marker comprises or consists of particles, which comprise or consist of a metal and/or a semimetal, the marker having at least three atomic species having a different atomic number. A marker and a labelled polymer are also provided. In addition, uses of the marker according to the invention are proposed. The marker according to the invention does not significantly affect the properties of the polymer and allows coded information in a wide variety of polymers to be read out in a simple and rapid manner and over long polymer lifetimes.

Marking batches of plastics (polymers) is a major challenge due to the large number of available plastic types. Starting from granules or any area of a component, it is practically impossible to draw any conclusions about the type and manufacturer of the material. However, this is essential from the point of view of material/product authenticity and from aspects of the circular economy of plastic products.

Decisive for the practical use of such a marking are its durability over the product lifetime, the embeddable information content, readability of the information, the size of the marking element and thus a possible interaction with the target properties of the material.

From the problem, i.e. the marking of plastic batches, thus results firstly the objective that the markers should be long-term resistant and suitable for outlasting the processing and molding process and the period of use. Furthermore, the information content that can be mapped in the marker should be sufficiently high to be able to distinguish a variety of plastic types and batches. In addition, the information encoded via the marker should also be easily and quickly readable from different plastic compositions. In addition, the marker should not significantly affect the usage properties of the product.

To date, plastics are usually not marked. However, in the context of the increasing importance of the circular economy, and of issues in the area of product authenticity, the need for practical marking procedures is growing. In the marking of plastics, fluorescence-based approaches, such as the introduction of organic fluorescent dyes, special fluorescent nanoparticles or the intrinsic fluorescence of the plastic itself, have been the main approaches pursued to date. For fluorescence color-based identification, material-specific decay times or maximum intensities at characteristic wavelengths in the visible range are used. However, due to the width of the spectral distribution of the fluorescent light reflected back from the plastic, the information content that can be represented is limited. In addition, a decrease in fluorescence intensity can be expected during processing and over the life of the article. This is especially true for organic fluorescent markers.

The intrinsic fluorescence of plastics is currently being used for sorting in the field of waste management. For the latter application, methods of hyperspectral image processing in the wavelength range of e.g. 900-1700 nm have also been mentioned recently, which can identify a material, but no targeted marking, i.e. no “storing” of defined information, can be realized.

For the labeling of plastics, there is initial work involving the introduction of macromolecules whose microstructure is specifically synthesized as binary-coded information. Synthesis of such macromolecules and readout of the information by tandem mass spectroscopy (MS/MS) is known in the prior art. In this case, the macromolecules are added during the synthesis of the used polymer or, as a second variant, introduced into the polymer by swelling. Extraction from the polymer and enrichment of the macromolecular markers has so far been a prerequisite for reading out (reading back) the marker information. Within a complex polymer blend, however, a readout is not currently possible.

Starting from this, it was the object of the present invention to indicate a method by which a labelled polymer can be provided that no longer has the disadvantages known in the prior art. In particular, the polymer provided should have a marker that is stable to the polymer manufacturing process and polymer processing, does not significantly affect the properties of the polymer, and allows readout of the information encoded via the marker in a wide variety of polymer types in a simple and rapid manner and over long polymer lifetimes. Further, such labelled polymer should be provided and uses thereof suggested.

The problem is solved by the method having the features of claim 1, the marker having the features of claim 9, the use of the marker having the features of claim 16, and the labelled polymer having the features of claim 17. The dependent claims disclose advantageous embodiments.

According to the invention, there is provided a method for preparing a labelled polymer, comprising the steps of
a) mixing polymer precursors with a marker and polymerizing the polymer precursors, resulting in a labelled polymer; or
b) mixing a polymer with a marker, resulting in a labelled polymer;

characterized in that the marker comprises or consists of particles, which comprise or consist of a metal and/or a semimetal, wherein the marker (for example, each particle of the marker) comprises at least three atomic species having a different atomic number.

Metal is understood to mean in particular an elementary metal (e.g. Cu), whereby alloys and/or mixtures of elementary metals are also understood to be included here (e.g. a ternary metal alloy). Semimetal is understood to mean in particular an elementary semimetal (e.g. Si), and mixtures of elementary semimetals are also understood to be included here. Thus, metal or semimetal means in particular no chemical compounds of metals or semimetals, for example no metal oxides (e.g. CuO) and no semimetal oxides (e.g. SiO₂). Nevertheless, for example, at least one ceramic may be another component of the marker.

Using method according to the invention, a labelled polymer can be provided that comprises a processing-stable marker that does not significantly affect the properties of the polymer and that enables readout of coded information in a wide variety of polymers in a simple and rapid manner and over long polymer lifetimes. For the first time, plastic batches can thus be marked with a relatively large number of variations, i.e. with a high information content, right from the production stage. The provided labelled polymer allows stable traceability of the polymer to the starting material and also to the manufacturer. In contrast to the fluorescence-based markers used in the prior art, a higher number of information bits can be used, which also do not overlap. In addition, in contrast to the fluorescence-based markers used in the prior art, no so-called “photo-bleaching” occurs, which significantly increases the long-term stability of the information encoded in the marker. Moreover, there is no thermal decomposition of the markers, which is otherwise observed with fluorescence-based markers from the prior art at higher processing temperatures. This circumstance also significantly prolongs the long-term stability of the information encoded in the marker compared to known prior art labelled polymers.

The method according to the invention may be characterized in that the marker comprises or consists of a metal, preferably a mixture of different metals and/or comprises or consists of a metal alloy, preferably comprises or consists of a metal alloy. The advantage here is that metal atoms can be easily detected via X-ray fluorescence analysis. The information encoded in the marker can thus be read out quickly and easily.

Further, the marker may comprise or consist of a semimetal. Semimetals (e.g. silicon) as a marker component have the advantage that they can be easily modified geometrically (e.g. inscribing a barcode via lithography) and/or chemically (e.g. doping), which allows the information content encoded in the marker to be increased in a simple manner.

Apart from this, the marker may additionally contain a ceramic. Ceramics as a marker component have the advantage that they are also resistant to high temperatures and have a high hardness. Consequently, these marker components allow high long-term stability even under harsh polymer processing conditions.

In a preferred embodiment, the marker is suitable for detection by X-ray fluorescence. X-ray fluorescence is a trace analytical method that exhibits high sensitivity for metal-comprising fillers in organic polymers. The detection limit of X-ray fluorescence is about one ppm. In addition, X-ray fluorescence can be used to quickly and easily read out the information of the marker.

In a preferred embodiment, the marker does not have atomic species derived from a catalyst used to catalyze the polymerization in step a) and/or included in the polymer from step b). The advantage here is that the information encoded in the marker is independent of the manufacturing process of the polymers and the information is not overlaid by unknown extraneous information. This facilitates a correct assignment of the read-out marker information to a specific polymer.

In another preferred embodiment, the marker does not have atomic species derived from a wall of a container and/or processing machine used in the polymerization of step a) and/or used in a preparation of the polymer of step b). The advantage here is that the information encoded in the marker is independent of the manufacturing process of the polymers and the information is not overlaid by unknown extraneous information. This facilitates a correct assignment of the read-out marker information to a specific polymer.

The marker can be geometrically modified. Preferably, the marker is geometrically modified in such a way that it has a geometric profile in the surface. Further, the marker may have been processed via a method selected from the group consisting of lithography, laser beam treatment, electron beam treatment, etching methods, and combinations thereof. In addition, the marker may have an inscribed pattern, preferably have an engraved and/or lithographically generated code, particularly preferably have an engraved and/or lithographically generated barcode and/or dot code. The additional geometric modification of the marker has the advantage of introducing additional levels of coding and thus increasing the information content of the marker. For example, the geometric modification can be used to code the manufacturer, index values, batch numbers, year of manufacture or date of manufacture of the polymer.

The marker may be chemically modified. Preferably, the marker is chemically modified in such a way that it has a chemically generated profile on the surface. Further, the marker may have been processed via a method selected from the group consisting of chemical activation of the particles, physical activation of the particles, covalent attachment of molecules to the particles, doping, ion implantation into the particles, attachment of nanodots to the particles, and combinations thereof. In addition, the marker may have or consist of nanodots, optionally nanodots chemically covalently bonded to the particles. In addition, the marker may have a chemical pattern. Chemical modification of the marker has the advantage of introducing additional levels of coding, thereby increasing the information content of the marker. For example, the geometric modification can be used to code the manufacturer, index values, batch numbers, or the year or date of manufacture of the polymer.

The marker can be admixed in the process in an amount such that the labelled polymer has 1 ppm to 1000 ppm marker, preferably 2 to 900 ppm marker, particularly preferably 5 to 800 ppm marker, especially preferably 10 to 700 ppm marker, most preferably 20 to 600 ppm marker, especially 50 to 500 ppm marker, relative to the total amount of labelled polymer. Addition of the marker in a larger amount may be advantageous to distinguish the signal of the marker from atomic species that have been forcibly introduced into the polymer by the polymer manufacturing process. Correct assignment of the read-out marker information to a specific polymer is thus facilitated.

Furthermore, the marker used in the method may comprise or consist of particles having a particle size in the range of 1 nm to 1000 μm, preferably 500 nm to 10 μm, particularly preferably 0.1 μm to 5 μm, especially 1 μm to 5 μm, as measured by a microscopic imaging method. Larger particles have the advantage that they can store a higher information content, for example after geometric and/or chemical modification. In addition, larger particles allow a difference to be determined with respect to components of the polymer that have entered the polymer via the manufacturing process (e.g. catalyst salts and/or catalyst complexes). This facilitates a correct assignment of the read-out marker information to a specific polymer.

According to the invention, there is further provided a marker comprising or consisting of particles, wherein the particles comprise or consist of a metal and/or a semimetal, wherein the marker (for example, each particle of the marker) comprises at least three atomic species having a different atomic number, and the marker is characterized in that it is geometrically modified and/or chemically modified.

The marker may be characterized by comprising or consisting of a mixture of different metals and/or a metal alloy, preferably comprising or consisting of a metal alloy.

Further, the marker may be characterized by comprising or consisting of a semimetal.

In addition, the marker may be characterized by further comprising a ceramic.

In addition, the marker may be suitable for detection by X-ray fluorescence.

In a preferred embodiment, the marker does not have atomic species derived from a catalyst used to catalyze a polymerization of a polymer and/or contained in a polymer.

In another preferred embodiment, the marker does not have atomic species derived from a container wall of a container used in a manufacture of a polymer.

The marker can be geometrically modified, preferably in such a way that it has a geometric profile in the surface. Further, the marker may have been processed via a method selected from the group consisting of lithography on the particles, laser beam treatment on the particles, electron beam treatment on the particles, etching methods, and combinations thereof. In addition, the marker may have an inscribed pattern, preferably have an engraved and/or lithographically generated code, particularly preferably have an engraved and/or lithographically generated barcode and/or dot code.

Moreover, the marker may be chemically modified, preferably in such a way that it has a chemically generated profile on the surface. The marker may further have been processed via a method selected from the group consisting of chemical activation of the particles, physical activation of the particles, covalent attachment of molecules to the particles, doping, ion implantation into the particles, attachment of nanodots to the particles, and combinations thereof. The marker may furthermore comprise or consist of nanodots, optionally nanodots chemically covalently bonded to the particles. In addition, the marker may have a chemical pattern.

The marker may be characterized as comprising or consisting of particles having a particle size in the range of 1 nm to 1000 μm, preferably 500 nm to 10 μm, particularly preferably 0.1 μm to 5 μm, especially 1 μm to 5 μm, as measured by a microscopic imaging technique.

The use of the marker according to the invention for the identification of a polymer (i.e., a polymer spiked with the marker) is proposed, wherein the identification is preferably performed via X-ray fluorescence and/or a microscopic method. In particular, the identification of the polymer is used to assign the polymer to a specific manufacturer, preferably to a specific batch of a specific manufacturer. The identification of the polymer can also be used to identify the polymer in a polymer recycling process. Furthermore, the identification of the polymer can be used to separate the polymer from other polymers in a polymer recycling process. In addition, the identification of the polymer can be used to document the history of the polymer.

According to the invention, there is also provided a labelled polymer characterized in that it comprises a marker, the marker comprising or consisting of particles, which comprise or consist of a metal and/or a semimetal, the marker (for example, each particle of the marker) comprising at least three atomic species having a different atomic number, the marker being in particular geometrically modified and/or chemically modified.

The labelled polymer may be characterized as being producible via the method according to the invention. Consequently, the labelled polymer may have all the features that are necessarily present in the labelled polymer via carrying out the method of the invention for its preparation.

By means of the following examples, the subject matter according to the invention will be explained in more detail, without wishing to limit it to the specific embodiments presented here.

### EXAMPLE 1

### Preparation of a Polymer Labelled with Metal Alloy Particles

To each of the different polymers PA6, PA66, PET and iPP, a respectively different powder of a metal alloy is added on a ppm scale, each powder having a metal alloy with three different metal atoms, i.e. having a ternary metal alloy. Mixing in the powder can be done, for example, in the course of synthesis of the various polymers in solution or in the course of the extrusion process of the various polymers during granule production.

The different polymers can thus be uniquely identified via X-ray fluorescence analysis, since each of the different polymers has a uniquely identifiable X-ray fluorescence spectrum.

### EXAMPLE 2

### Preparation of a Polymer Labelled with Semimetal Particles

As a first step, a binary information (e.g. a barcode) is inscribed into a silicon wafer (e.g. via lithography, a laser beam and/or an electron beam), which binary information can be read microscopically. Furthermore, the silicon wafer can optionally be chemically modified (e.g. via doping) to encode further information in the silicon wafer.

In this example, the silicon wafer is coated on its backside with a layer of a metal alloy that encodes additional information, such as an assignment of a particular type of polymer or an indication that the marker in the polymer has additional information, which in this case is encoded in the silicon component of the marker.

The silicon wafers are then converted into a particulate marker (marker powder), e.g. by milling processes. In this case, the particles have not only the metal alloy, but also a silicon component that comprises the barcode.

X-ray fluorescence analysis can be used to quickly read out the metallic and semimetallic components of the marker. In addition, the barcode of the silicon component of the marker can be read out via a further method (e.g. a microscopic method).

1-18. (canceled)

19. A method for preparing a labelled polymer, comprising the steps of
(a) mixing polymer precursors with a marker and polymerizing the polymer precursors, resulting in a labelled polymer; or
(b) mixing a polymer with a marker, resulting in a labelled polymer;
wherein the marker comprises particles comprising a metal and/or a semimetal, the marker having at least three atomic species having a different atomic number.

20. The method according to claim 19, wherein the marker
(i) comprises a metal, a mixture of different metals, and/or a metal alloy;
(ii) comprises a semimetal;
(iii) comprises a ceramic; and/or
(iv) is suitable for detection by X-ray fluorescence.

21. The method according to claim 19, wherein the marker does not comprise atomic species originating from a catalyst utilized to catalyze the polymerization in step a) and/or contained in the polymer from step b).

22. The method according to claim 19, wherein the marker does not comprise atomic species originating from a wall of a container and/or a processing machine utilized in the polymerization of step a) and/or utilized in a preparation of the polymer of step b).

23. The method according to claim 19, wherein the marker is geometrically modified.

24. The method according to claim 23, wherein the marker is geometrically modified in such a way that it
(i) has a geometric profile in the surface; and/or
(ii) has been processed via a method selected from the group consisting of lithography on the particles, laser beam treatment on the particles, electron beam treatment on the particles, etching methods, and combinations thereof; and/or
(iii) has an inscribed pattern.

25. The method according to claim 19, wherein the marker is chemically modified.

26. The method according to claim 25, wherein the marker is chemically modified in such a way that it
(i) has a chemically generated profile on the surface;
(ii) has been processed via a method selected from the group consisting of chemical activation of the particles, physical activation of the particles, covalent attachment of molecules to the particles, doping, ion implantation into the particles, attachment of nanodots to the particles, and combinations thereof;
(iii) comprises or consists of nanodots, optionally nanodots that are chemically covalently bonded to the particles; and/or
(iv) has a chemical pattern.

27. The method according to claim 19, wherein the marker is admixed in an amount such that the labelled polymer has 1 ppm to 1000 ppm marker with respect to the total amount of the labelled polymer.

28. The method according to claim 19, wherein the marker comprises particles having a particle size in the range of 1 nm to 1000 μm as measured by a microscopic imaging method.

29. A marker comprising particles, said particles comprising a metal and/or a semimetal, said marker comprising at least three atomic species having a different atomic number, wherein said marker is geometrically modified and/or chemically modified.

30. The marker according to claim 29, wherein the marker
(i) comprises a mixture of different metals and/or a metal alloy;
(ii) comprises or consists of a semimetal;
(iii) comprises a ceramic; and/or
(iv) is suitable for detection by X-ray fluorescence.

31. The marker according to claim 29, wherein the marker does not comprise atomic species derived from a catalyst used to catalyze a polymerization of a polymer and/or contained in a polymer.

32. The marker according to claim 29, wherein the marker does not comprise atomic species originating from a container wall of a container utilized in a production of a polymer.

33. The marker according to claim 29, wherein the marker is geometrically modified.

34. The marker according to claim 33, wherein the marker is geometrically modified in such a way that it
(i) has a geometric profile in the surface;
(ii) has been processed via a method selected from the group consisting of lithography on the particles, laser beam treatment on the particles, electron beam treatment on the particles, etching methods, and combinations thereof; and/or
(iii) has an inscribed pattern.

34. The marker according to claim 29, wherein the marker is chemically modified.

35. The marked according to claim 34, wherein the marker is chemically modified in such a way that it
(i) has a chemically generated profile on the surface;
(ii) has been processed via a method selected from the group consisting of chemical activation of the particles, physical activation of the particles, covalent attachment of molecules to the particles, doping, ion implantation into the particles, attachment of nanodots to the particles, and combinations thereof;
(iii) comprises or consists of nanodots, optionally nanodots that are chemically covalently bonded to the particles; and/or
(iv) has a chemical pattern.

36. The marker according to claim 29, wherein the marker comprises particles having a particle size in the range of 1 nm to 1000 μm, as measured by a microscopic imaging method.

37. A method of assigning a polymer to a specific manufacturer, identifying a polymer in the context of polymer recycling; separating a polymer from other polymers in a polymer recycling process; and/or documenting history of a polymer, the method comprising utilizing a marker according to claim 29 in said method.

38. A labelled polymer comprising at least one marker, said marker comprising particles comprising or consisting of a metal and/or a semimetal, said marker comprising at least three types of atoms having a different atomic number.
